(19) United States
(12) Patent Application Publication
(10) Pub. No.: US 2002/0029233 A1
(43) Pub. Date: Mar. 7, 2002

(54) Bit string detecting circuit

(76) Inventor: Fumihide Kitamura, Tokyo (JP)

Correspondence Address: LEYDIG VOIT & MAYER, LTD, 700 THIRTEENTH ST. NW, SUITE 300, WASHINGTON, DC, 20005-3960, US

(21) Appl. No.: 09/749,909

(22) Filed: Dec. 29, 2000

(30) Foreign Application Priority Data
Sep. 5, 2000 (JP) 2000-269277

(51) Int. Cl. G06F 7/00

(52) U.S. Cl. 708/212; 708/210

(57) ABSTRACT

An input bit string is latched sequentially by a D latch initialized to the logical level “1” and a plurality of D latches initialized to logical level “0”. If the data bit released from the last D latch, of the plurality of D latches, has a logical level “1”, a detection enabling circuit continuously keeps outputting a signal having a logical level “1”. This detection enabling circuit comprises an OR gate and another D latch. If the signal output by the detection enabling circuit has a logical level “1” and the bit pattern held in all of the D latches is “11111”, then an AND gate outputs a bit string detection signal having a logical level “1”.

### FIELD OF THE INVENTION

The present invention relates to a bit string detecting circuit for effecting 0 insertion/0 deletion and 1 insertion/1 deletion used in serial data transfer, such as HDLC (High-Level Data Link Control) and BEAN (Body Electronics Area Network). This invention also provides a novel technique to be applied in the detection of a bit string having any desired pattern.

### BACKGROUND OF THE INVENTION

In data communication according to the HDLC procedure, BEAN procedure or the like, all the data is transferred bit by bit. As a result, a particular bit pattern, such as “111111” or “000000”, is used as a flag, so that the start and end of the data transfer can be confirmed at the receiver's end. In the data communication according to the foregoing procedures, the start position of the effective data is conformed by identifying the flag, and synchronization of data transfer at the sender's end and receiver's end is established. However, sometimes a bit pattern, which is the same as the flag, is present in the data frame. In such a case, it becomes impossible to judge whether that bit pattern represents data or the flag. Accordingly, data can not be transmitted or received normally.

In order to overcome this problem, in case of adopting six consecutive bits “1”, that is “111111”, as the flag, if there is a data pattern of five consecutive bits “1”, then a bit “0” is inserted immediately after the bit pattern. That is, data is processed so as not to generate six consecutive bits “1” in a data frame. This is known as 0 insertion.

FIG. 10 shows the configuration required for 0 insertion. As shown in FIG. 10, transmitting data generated at the sender's end is held in a transmitting data register 101, and the transmitting data held therein is inputted into a 11111 bit string detecting circuit 102 as a serial bit string. The 11111 bit string detecting circuit 102 delivers the input bit string to a 0 insertion circuit 103 in the following stage. If the 11111 bit string detecting circuit 102 detects that the input bit string coincides with a bit pattern “11111”, then it inputs a detection signal into the 0 insertion circuit 103.

Upon receipt of the detection signal from the 11111 bit string detecting circuit 102, the 0 insertion circuit 103 inserts “0” immediately after the bit pattern “11111”, and outputs the result as an output bit string. On the other hand, if the 0 insertion circuit 103 does not receive the detection signal, it outputs the bit string received from the 11111 bit string detecting circuit 102 as it is as the output bit string.

At the receiver's end, conversely, if a bit pattern of five consecutive bits “1” is detected in a data frame to which the 0 insertion was effected, the bit “0” immediately after the bit pattern is deleted. This is known as 0 deletion. FIG. 11 shows the configuration required for 0 deletion.

As shown in FIG. 11, the 0 insertion effected bit string is sequentially inputted into a 11111 bit string detecting circuit 201 as an input bit string at the receiver's end. The 11111 bit string detecting circuit 201 delivers the input bit string to a 0 deletion circuit 202 in the following stage. If the 11111 bit string detecting circuit 201 detects that the input bit string coincides with a bit pattern “11111”, it inputs a detection signal into the 0 deletion circuit 202.

Upon receipt of the detection signal from the 11111 bit string detecting circuit 201, the 0 deletion circuit 202 deletes “0” immediately after the bit pattern “11111”, that is, “0” inserted by the 0 insertion, and inputs the result to a received data register 203 in the following stage. On the other hand, when the 0 deletion circuit 202 does not receive the detection signal, it outputs the bit string received from the 11111 bit string detecting circuit 201 as it is to the received data register 203. The received data register 203 holds the bit string received from the 0 deletion circuit 202 temporarily, and outputs the same sequentially as received data.

Effecting the 0 insertion/0 deletion can prevent generation of a bit pattern which is same as the flag in a data frame, thereby making it possible to conduct binary data transfer without specifically concerning transparency.

Next, operation of the 11111 bit string detecting circuit 201 will be explained. FIG. 12 is a circuit diagram showing an arrangement of the 11111 bit string detecting circuit. As shown in FIG. 12, the 11111 bit string detecting circuit 201 comprises five serially connected D latches 111 to 115, an inverter G111 for inverting an initialization pulse and inputting the same to a reset terminal R of each D latch, and a multi-input AND gate F110 for receiving an output signal from a data output terminal Q of each D latch to carry out an AND operation and outputting the result as a 11111 detection signal.

In order to activate the 11111 bit string detecting circuit 201, an initialization pulse having a logical level “1” is inputted, whereupon the logical level in each of the D latches 111 to 115 is reset to “0”. Subsequently, an input bit string is delivered sequentially throughout the D latches 111 to 115 in synchronization with a shift clock. The multi-input AND gate F110 constantly receives the data held in the D latches 111 to 115, that is, a signal outputted from the data output terminal Q of each, and outputs a signal having the logical level “1” as the 11111 detection signal only when all the D latches 111 to 115 have the logical level “1”.

In other words, when the 11111 detection signal has a logical level “1”, it means that a bit pattern “11111” is detected in the input bit string. The arrangement and operation of the 11111 bit string detecting circuit 102 at the sender's end are the same as those of the above-explained 11111 bit string detecting circuit 201.

The above example explained a case of the 0 insertion/0 deletion using six consecutive bits “1”, that is, “111111”, as the flag. However, six consecutive bits “0”, that is, “000000”, may also be used as the flag. In this case, binary data can be transferred normally by effecting 1 insertion/1 deletion.

FIG. 13 shows the configuration required for 1 insertion. In FIG. 13, a transmitting data register 301 is the same as the transmitting data register 101 shown in FIG. 10, and the explanation of the same is omitted herein. As shown in FIG. 13, in order to effect the 1 insertion at the sender's end, a 00000 bit string detecting circuit 302 delivers an input bit string to a 1 insertion circuit 303 in the following stage. If the 00000 bit string detecting circuit 302 detects that the bit string coincides with a bit pattern “00000”, it inputs a detection signal into the 1 insertion circuit 303.

Upon receipt of the detection signal from the 00000 bit string detecting circuit 302, the 1 insertion circuit 303 inserts “1” immediately after the bit pattern “00000”, and outputs the result as an output bit string.

FIG. 14 shows the configuration required for the 1 deletion. In FIG. 14, a received data register 403 is the same as the received data register 203 shown in FIG. 11, and the explanation of the same is omitted herein. As shown in FIG. 14, in order to effect the 1 deletion at the receiver's end, the 00000 bit string detecting circuit 401 delivers an input bit string to the 1 deletion circuit 402 in the following stage. If the 00000 bit string detecting circuit 401 detects that the bit string coincides with a bit pattern “00000”, it inputs a detection signal into the 1 deletion circuit 402.

Upon receipt of the detection signal from the 00000 bit string detecting circuit 401, the 1 deletion circuit 402 deletes “1” immediately after the bit pattern “00000”, that is “1” inserted by the 1 insertion, and inputs the result to the received data register 403 in the following stage.

Next, operation of the 00000 bit string detecting circuit 401 will be explained. FIG. 15 is a circuit diagram showing an arrangement of the 00000 bit string detecting circuit. As shown in FIG. 15, the 00000 bit string detecting circuit 401 comprises serially connected five D latches 311 to 315, an inverter G311 for inverting an initialization pulse and inputting the same to a set terminal S of each D latch, and a multi-input AND gate F310 for receiving an output signal from an anti-phase data output terminal /Q of each D latch to carry out an AND operation and outputting the result as a 00000 detection signal.

In order to activate the 00000 bit string detecting circuit 401, an initialization pulse having a logical level “1” is inputted, whereupon the logical level in each of the D latches 311 to 315 is set to “1”. Subsequently, an input bit string is delivered sequentially throughout the D latches 311 to 315 in synchronization with a shift clock. The multi-input AND gate F310 constantly receives the data held in the D latches 311 to 315, that is, a signal outputted from the anti-phase data output terminal /Q of each, and outputs a signal having the logical level “1” as the 00000 detection signal only when all the D latches 311 to 315 have the logical level “0”. In other words, when the 00000 detection signal has a logical level “1”, it means that the bit pattern “00000” is detected in the input bit string. The arrangement and operation of the 00000 bit string detecting circuit 302 at the sender's end are the same as those of the above-described 00000 bit string detecting circuit 401.

Thus, in effecting the 0 insertion/0 deletion, the 11111 bit string detecting circuit has to reset at least the D latch in the first stage to “0” as the initialized state. This is required in order to avoid that the five D latches hold a data “11111”. In other words, this is required, in order to avoid erroneous detection until all the five bits forming an input bit string are inputted.

Likewise, in effecting the 1 insertion/1 deletion, the 00000 bit string detecting circuit has to set at least the D latch in the first stage to “1” in the initialized state, so that the five D latches do not hold the data “00000”, in other words, erroneous detection can be prevented until all the five bits forming an input bit string are inputted.

Only 0 insertion/0 deletion is employed in data communication according to the HDLC procedure. On the contrary, both the 0 insertion/0 deletion and 1 insertion/1 deletion are employed in data communication according to the BEAN procedure. Therefore, in the BEAN procedure, and the 11111 bit string detecting circuit and 00000 bit string detecting circuit have to be provided at both the sender's end and receiver's end. However, as has been discussed above, the initial states of the 11111 bit string detecting circuit and 00000 bit string detecting circuit are different from each other, and it is quite difficult to construct these detecting circuits from common D latches.

In addition, in case that the polarity of a signal changes between the data sender's end and receiver's end, a transmitter/receiver incorporating both a transmitter and a receiver has to be provided with two different detecting circuits. That is, the 11111 bit string detecting circuit at the sending portion, and the 00000 bit string detecting circuit at the receiving portion. For this reason, the conventional transmitter, receiver is provided with a special circuit to effect both the 0 insertion/0 deletion and 1 insertion/1 deletion or to be adapted to a communication method, in which the polarity of a signal changes between the sender's end and receiver's end.

FIG. 16 shows the configuration that effects both the 0 insertion and 1 insertion. In FIG. 16, like components with respect to FIG. 10 and FIG. 13 are labeled with like legends, and the explanation of these components is not repeated. The arrangement shown in FIG. 16 includes a common transmitting data register 101, and a 11111 bit string detecting circuit 102 and a 0 insertion circuit 103 for effecting the 0 insertion, and a 00000 bit string detecting circuit 302 and a 1 insertion circuit 303 for effecting the 1 insertion.

It should be appreciated that selection of an output bit string from a 0 insertion effected bit string or a 1 insertion effected bit string is controlled by switches SW 111 to 113, and that each of the bit strings inputted into the 0 insertion circuit 103 and 1 insertion circuit 303 is received from the 11111 bit string detecting circuit 102.

In other words, the arrangement shown in FIG. 16 effects the 0 insertion and 1 insertion by selectively activating one of the systems having the arrangements shown in FIG. 10 and FIG. 13 with the switches SW 111 to 113.

Also, FIG. 17 shows a configuration that effects both the 0 deletion and 1 deletion. In FIG. 17, like components with respect to FIG. 11 and FIG. 14 are labeled with like legends, and the explanation of these components is not repeated. The arrangement shown in FIG. 17 includes a common received data register 203, and a 11111 bit string detecting circuit 201 and a 0 deletion circuit 202 for effecting the 0 deletion, and a 00000 bit string detecting circuit 401 and a 1 deletion circuit 402 for effecting the 1 deletion.

It should be appreciated that selection of an output bit string from a 0 deletion effected bit string or a 1 deletion effected bit string is controlled by switches SW 211 to 213, and that each of the bit strings inputted into the 0 deletion circuit 202 and 1 deletion circuit 402 is received from the 11111 bit string detecting circuit 201.

In other words, the arrangement shown in FIG. 17 effects the 0 deletion and 1 deletion by selectively activating one of the systems having the arrangements shown in FIG. 11 and FIG. 14 with the switches SW 211 to 213.

The following description will describe a 11111/00000 bit string detecting circuit (hereinafter, referred to as the first bit string detecting circuit) incorporating the 11111 bit string detecting circuit 201 and 00000 bit string detecting circuit 401 into one body as shown in FIG. 17. FIG. 18 is a circuit diagram showing an arrangement of the 11111/00000 bit string detecting circuit. In FIG. 18, like components with respect to FIG. 12 and FIG. 15 are labeled with like legends, and the explanation of these components is not repeated. A 11111/00000 bit string detecting circuit 300 shown in FIG. 18 includes D latches 111 to 115 and a multi-input AND gate F110 for detecting a bit pattern “11111”, D latches 311 to 315 and a multi-input AND gate F310 for detecting a bit pattern “00000”, and an inverter G111 for inverting an initialization pulse and inputting the same to a reset terminal R of each of the D latches 111 to 115 and a set terminal S of each of the D latches 311 to 315.

In other words, the 11111/00000 bit string detecting circuit 300 is composed of the commonly used inverter G 111, and a combination of the arrangement of the 11111 bit string detecting circuit 201 shown in FIG. 12 and the arrangement of the 00000 bit string detecting circuit 401 shown in FIG. 15. Thus, the 11111/00000 bit string detecting circuit 300 operates in the same manner as the circuits shown in FIG. 12 and FIG. 15 except that the D latches 111 to 115 are reset to “0” while the D latches 311 to 315 are set to “1” in response to the common initialization pulse.

Also, as another example (hereinafter, referred to as the second bit string detecting circuit) of the 11111/00000 bit string detecting circuit for effecting both the 0 deletion and 1 deletion, an arrangement which makes the D latches in the bit string detecting circuit to be used commonly is known. FIG. 19 shows the configuration of this 11111/00000 bit string detecting circuit. The 11111/00000 bit string detecting circuit 400 shown in FIG. 19 comprises five serially connected D latches 511 to 515, an inverter G111 for inverting an initialization pulse and inputting the same to a reset terminal R of each D latch, a multi-input AND gate F110 for receiving an output signal from a data output terminal Q of each D latch to carry out an AND operation and outputting the operation result as a 11111 detection signal, and a multi-input AND gate F310 for receiving an output signal from an anti-phase data output terminal /Q of each D latch to carry out an AND operation and outputting the operation result as a 00000 detection signal.

In particular, as shown in FIG. 19, when the D latches are used commonly and each D latch is reset to “0” at the initial stage, a bit pattern “00000” may be detected erroneously before an input bit string is inputted into all the five D latches.

Hence, the 11111/00000 bit string detecting circuit 400 is provided with a counter 500 for disabling detection of a bit string after the initialization until the input bit string is inputted into all the five D latches. The counter 500 starts to count a shift clock upon input of the initialization pulse, and for example, inputs the logical level “0” to the multi-input AND gates F110 and F310 until it counts five clocks. Consequently, erroneous detection in the initialized state as to the bit pattern “00000” can be avoided.

However, in the first bit string detecting circuit, the 11111 bit string detecting circuit and 00000 bit string detecting circuit are merely combined, and the number of components cannot be reduced.

On the other hand, in the second bit string detecting circuit, although the D latches are used commonly, an additional circuit, such as the counter, which has a relatively large circuit area, is necessary. Thus, there occurs a problem that the downsizing effect of the circuit realized by using the common D latches is eliminated.

Further, in the conventional bit string detecting circuit, a bit pattern of the detection subject is fixed. Hence, it is quite difficult to change a bit pattern of the detection subject or detect more than one bit pattern simultaneously.

### SUMMARY OF THE INVENTION

It is an object of the present invention to provide a bit string detecting circuit capable of preventing erroneous detection at the start of the bit string detection and detecting a plurality of different bit patterns without demanding any additional component.

In the bit string detecting circuit according to the present invention a first latch unit provided in the first stage of the bit string detecting circuit is set with a data bit having the first logical state at the initialization, and the detection enabling signal is continuously inputted into the bit string detecting unit when and after the above bit data reaches the detection enabling unit through the second latch unit in synchronization with the clock. Thus, the bit string detecting function is maintained in the disabled state until the detection subject data is inputted into the first latch unit and the second latch unit to their full, and any desired bit pattern can be detected.

Other objects and features of this invention will become apparent from the following description with reference to the accompanying drawings.

### BRIEF DESCRIPTION OF THE DRAWINGS

FIG. 1 is a circuit diagram of a bit string detecting circuit of a first embodiment;

FIG. 2 is an explanatory view of an operation of the bit string detecting circuit of the first embodiment;

FIG. 3 is a circuit diagram of a bit string detecting circuit of a second embodiment;

FIG. 4 is a circuit diagram of a bit string detecting circuit of a third embodiment;

FIG. 5 is a circuit diagram of a bit string detecting circuit of a fourth embodiment;

FIG. 6 is a circuit diagram of a bit string detecting circuit of a fifth embodiment;

FIG. 7 is a circuit diagram of a bit string detecting circuit of a sixth embodiment;

FIG. 8 is a circuit diagram of a bit string detecting circuit of a seventh embodiment;

FIG. 9 is a circuit diagram of an HDLC receiving circuit adapting a bit string detecting circuit of an eighth embodiment;

FIG. 10 shows a configuration required for 0 insertion;

FIG. 11 shows a configuration required for 0 deletion;

FIG. 12 is a circuit diagram showing a configuration of a conventional 11111 bit string detecting circuit;

FIG. 13 shows a configuration required for 1 insertion;

FIG. 14 shows a configuration required for 1 deletion;

FIG. 15 is a circuit diagram showing a configuration of a conventional 00000 bit string detecting circuit;

FIG. 16 is an explanatory view of an arrangement that effects both the 0 insertion and 1 insertion;

FIG. 17 is an explanatory view of an arrangement that effects both the 0 deletion and 1 deletion;

FIG. 18 is a circuit diagram showing an arrangement of a conventional 11111/00000 bit string detecting circuit; and

FIG. 19 is a circuit diagram showing another arrangement of the conventional 11111/00000 bit string detecting circuit.

### DESCRIPTION OF THE PREFERRED EMBODIMENTS

Preferred embodiments of a bit string detecting circuit of the present invention are explained below with reference to the accompanying drawings. However, this invention is not limited only to the following embodiments.

A bit string detecting circuit according to a first embodiment will now be explained. This bit string detecting circuit comprises a combination circuit and a D latch in addition to the conventional configuration. These additional components are provided for setting, of all the D latches that latch a bit string, the D latch in the first stage alone to “1” at initialization, and generating a signal that disables detection of a bit pattern until “1” held in the D latch in the first stage is released from the D latch positioned in the same stage number as the bit length of the bit pattern of the detection subject.

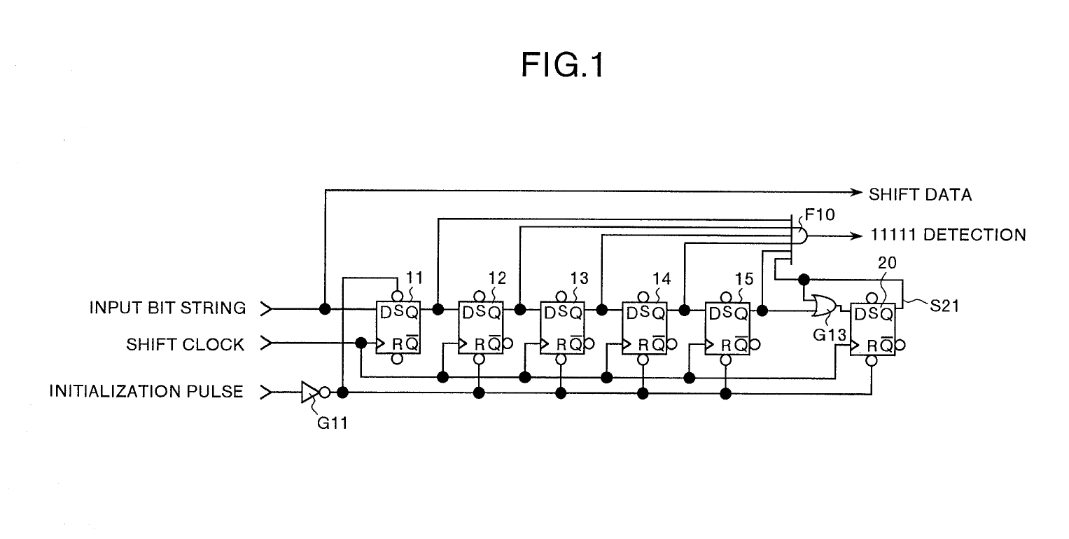

FIG. 1 is a circuit diagram of the bit string detecting circuit of the first embodiment. This figure specifically shows a circuit which detects a bit pattern “11111” to effect the 0 deletion. This bit string detecting circuit comprises five serially connected D latches 11 to 15, an inverter G11 for inverting an initialization pulse and inputting the same to a set terminal S of the D latch 11 and a reset terminal R of each of the D latches 12 to 15, a D latch 20 for generating a detection enabling signal for enabling detection of a bit pattern, an OR gate G13 for receiving a signal outputted from a data output terminal Q of the D latch 15 (hereinafter, referred to as a phase data output signal) at one input terminal and a phase data output signal from the D latch 20 at the other input terminal, and a multi-input AND gate F10 for receiving phase data output signals from the D latches 11 to 15 and 20 to carry out an AND operation and outputting the operation result as a 11111 detection signal.

The bit string detecting circuit shown in FIG. 1 detects the bit pattern “11111” as an object for comparison. This circuit delivers an input bit string to a not shown 0 deletion circuit in the latter stage, and upon detection of the bit pattern “11111”, it outputs a detection signal to the 0 deletion circuit. Hence, the D latches 11 to 15 hold an input bit string inputted sequentially from the D latch 11 in the first stage up to five bits in synchronization with a shift clock, and input the 5-bit bit pattern held therein to the multi-input AND gate F10.

Even when the bit string held in the D latches 11 to 15 coincides with the bit pattern “11111”, if the other input signal S21 to the multi-input AND gate F10 is in the logical state “0”, the multi-input AND gate F10 does not output data “1” serving as the detection signal of “11111”. Thus, whether to enable the 11111 detection or not is determined by the signal S21. This means that enabling and disabling of the 11111 detection are controlled by a combination circuit (hereinafter, referred to as the detection enabling circuit) which includes the OR gate G13 and D latch 20.

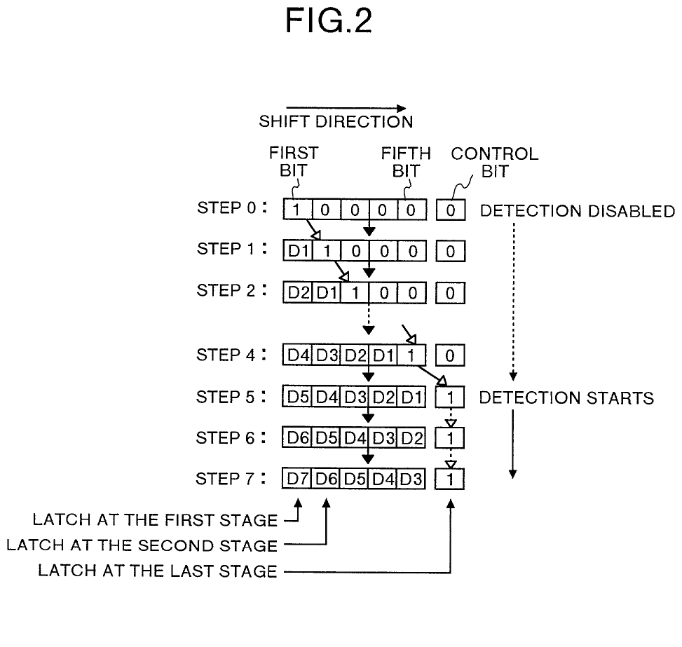

Next, operation of the bit string detecting circuit will be explained. FIG. 2 is an explanatory view of an operation of the bit string detecting circuit of the first embodiment. In order to activate the bit string detecting circuit, an initialization pulse having the logical level “1” is inputted, whereupon data in the D latch 11 is set to “1”, and data in the D latches 12 to 15 and 20 is reset to “0”. Accordingly, the multi-input AND gate F10 outputs data “0”. In other words, the bit pattern “11111” is not detected. When the signal S21 outputted from the D latch 20 indicates “0”, as explained above, this state will be referred to as the detection disabled state.

In other words, in the initial state, data “1” is held in the D latch 11, and data “0” is held in the rest of the D latches 12 to 15 and 20 (Step 0 in FIG. 2). After the initial state, when the first bit “D1” in the input bit string is inputted in synchronization with the shift clock, the D latch 20 latches an output from the OR gate G13.

Because the D latch 20 outputs the signal S21 indicating “0” at the initial state, a signal having the logical level “0” is inputted into one input terminal of the OR gate G13. Also, output data from the D latch 15 which was reset to “0” during the initialization, that is, a signal having the logical level “0”, is inputted into the other input terminal of the OR gate G13. Accordingly, the OR gate G13 outputs a signal having the logical level “0”, and the D latch 20 holds the data “0”. This means that the detection disabled state is still maintained.

At the input of the same shift clock, the D latch 15 latches the data “0” held in the D latch 14, the D latch 14 latches the data “0” held in the D latch 13, the D latch 13 latches the data “0” held in the D latch 12, the D latch 12 latches the data “1” held in the D latch 11, and the D latch 11 latches data “D1”. In short, the D latches 11 to 15 and 20 hold “D1”, “1”, “0”, “0”, “0”, and “0”, respectively (Step 1).

Subsequently, when the second bit “D2” in the input bit string is inputted, the D latch 20 latches an output from the OR gate G13. Here, the signal S21 has the logical level “0” and the D latch 15 outputs the data “0”. Thus, the OR gate G13 outputs “0” in the same manner as above, and the D latch 20 takes in that “0” and holds the same therein. This means that the detection disabled state is still maintained.

At the input of the same shift clock, the D latch 15 latches the data “0” held in the D latch 14, the D latch 14 latches the data “0” held in the D latch 13, the D latch 13 latches the data “1” held in the D latch 12, the D latch 12 latches the data “D1” held in the D latch 11, and the D latch 11 latches the data “D2”. In short, the D latches 11 to 15 and 20 hold “D2”, “D1”, “1”, “0”, “0”, and “0”, respectively (Step 2).

Subsequently, when the third bit “D3” in the input bit string is inputted, the D latch 20 latches an output from the OR gate G13. Here, because the signal S21 has the logical level “0” and the D latch 15 outputs the data “0”, the OR gate G13 outputs “0” in the same manner as above, and the D latch 20 takes in that “0” and holds the same therein. This means that the detection disabled state is still maintained.

At the input of the same shift clock, the D latch 15 latches the data “0” held in the D latch 14, the D latch 14 latches the data “1” held in the D latch 13, the D latch 13 latches the data “D1” held in the D latch 12, the D latch 12 latches the data “D2” held in the D latch 11, and the D latch 11 latches the data “D3”. In short, the D latches 11 to 15 and 20 hold “D3”, “D2”, “D1”, “1”, “0”, and “0”, respectively (Step 3).

Subsequently, when the fourth bit “D4” in the input bit string is inputted, the D latch 20 latches an output from the OR gate G13. Here, because the signal S21 has the logical level “0” and the D latch 15 outputs the data “0”, the OR gate G13 outputs “0” in the same manner as above, and the D latch 20 takes in that “0” and holds the same therein. This means that the detection disabled state is still maintained.

At the input of the same shift clock, the D latch 15 latches the data “1” held in the D latch 14, the D latch 14 latches the data “D1” held in the D latch 13, the D latch 13 latches the data “D2” held in the D latch 12, the D latch 12 latches the data “D3” held in the D latch 11, and the D latch 11 latches the data “D4”. In short, the D latches 11 to 15 and 20 hold “D4”, “D3”, “D2”, “D1”, “1”, and “0”, respectively (Step 4).

Subsequently, when the fifth bit “D5” in the input bit string is inputted, the D latch 20 latches an output from the OR gate G13. Here, because the D latch 20 outputs “0”, which has been held therein, as the signal S21, this signal having the logical level “0” is inputted into one input terminal of the OR gate G13. Also, output data from the D latch 15, that is, “1”, is inputted into the other input terminal of the OR Gate G13. Thus, the output from the OR gate G13 is determined by the logical state of the signal inputted into the other input terminal.

In other words, at the input of the shift clock, the OR gate G13 outputs “1”, and the D latch 20 takes in that signal having the logical level “1” and holds the same therein. Consequently, the phase data output signal S21 from the D latch 20 indicates “1”. In particular, the state where the signal S21 outputted from the D latch 20 indicates “1” is referred to as the detection enabled state.

At the input of the same shift clock, the D latch 15 latches the data “D1” held in the D latch 14, the D latch 14 latches the data “D2” held in the D latch 13, and the D latch 13 latches the data “D3” held in the D latch 12, the D latch 12 latches the data “D4” held in the D latch 11, and the D latch 11 latches the data “D5”. In other words, the D latches 11 to 15 and 20 hold “D5”, “D4”, “D3”, “D2”, “D1”, and “1”, respectively (Step 5).

In the state of Step 5, because the signal S21 has the logical level “1”, an output from the multi-input AND gate F10 is determined by the logical states of the phase data output signals from the D latches 11 to 15. In other words, when all the D latches 11 to 15 hold the data “1” in the detection enabled state (in the above case, all the D1 to D5 indicate “1”), the detection signal having the logical level “1” is outputted from the multi-input AND gate F10. When all the D latches 11 to 15 do not hold the data “1”, the output from the multi-input AND gate F10 has the logical level “0”, and the bit pattern “11111” is not.

Subsequent to Step 5, when the sixth bit “D6” in the input bit string is inputted, the D latch 20 latches an output from the OR gate G13. Here, because the D latch 20 outputs “1”, which has been held therein, as the signal S21, the OR gate G13 outputs “1”. In other words, the D latch 20 takes in that signal having the logical level “1” and holds the same therein. Hence, the signal S21 outputted from the D latch 20 still has “1”. This means that the detection enabled state is still maintained.

At the input of the same shift clock, the D latch 15 latches the data “D2” held in the D latch 14, the D latch 14 latches the data “D3” held in the D latch 13, the D latch 13 latches the data “D4” held in the D latch 12, the D latch 12 latches the data “D5” held in the D latch 11, and the D latch 11 latches the data “D6”. In short, the D latches 11 to 15 and 20 hold “D6”, “D5”, “D4”, “D3”, “D2”, and “1”, respectively (Step 6).

Because the detection enabled state is still maintained in the state of Step 6, whether the bit string D2 to D6 held in the D latches 11 to 15 coincides with the bit pattern “11111” or not is detected.

In addition, subsequent to Step 6, even when the seventh bit “D7” in the input bit string is inputted (Step 7), the D latch 20 still holds the data “1”, and the detection enabled state is maintained. In other words, once the D latch 20 latches a signal having the logical level “1”, the detection enabled state for the bit pattern “11111” is maintained until the D latch 20 is reset by the initialization pulse again.

As has been discussed, according to the bit string detecting circuit of the first embodiment, of all the D latches 11 to 15 that sequentially latch the input bit string, the D latch 11 in the first stage alone is set to “1” at the initialization, and until that “1” held in the D latch 11 is released from the D latch 15 and latched by the D latch 20, the D latch 20 maintains the detection disabled state by inputting the signal having the logical level “0” to the multi-input AND gate F10 that receives the data output from each of the D latches 11 to 15 and detects the bit pattern “11111”, and after the D latch 20 latches “1”, the D latch 20 inputs the signal having the logical level “1” to the multi-input AND gate F10, thereby switching the detection disabled state to the detection enabled state. Therefore, the bit string detecting function can be maintained in the disabled state until the subjected detection data is inputted into the bit string detecting circuit to its full without requiring any additional circuit, such as a counter, and erroneous bit string detection occurring at the start of the shift input of the subjected detection data can be prevented.

The first embodiment explained a case where the 5-bit bit pattern “11111” is detected. However, a bit pattern “00000” can be also detected by connecting the inputs of the multi-input AND gate F10 not to the data output terminal Q, but to an anti-phase data output terminal /Q of each D latch. In addition, a desired bit pattern can be detected by inputting data to the multi-input AND gate F10 by selecting the data from either the data output terminal Q or anti-phase data output terminal /Q of each D latch. Further, a bit pattern other than 5-bit long can be detected by changing the stage number of the serially connected D latches and the number of inputs of the multi-input AND gate F10.

Also, in the foregoing example, the D latch 11 in the first stage is set to the logical level “1” and the other D latches 12 to 15 and 20 are reset to the logical level “0”. However, at the initial state, the D latch 11 in the first stage may be reset to the logical level “0” and the other D latches 12 to 15 and 20 may be set to the logical level “1” by changing the combination circuit including the D latch 20 such that it maintains the logical level “0” and outputs the detection enabling signal having the logical level “1” once the logical level “0” is inputted.

Next, a bit string detecting circuit according to a second embodiment will be explained. The bit string detecting circuit of the second embodiment is characterized in that switches for selecting either phase data output signals or anti-phase data output signals from the D latches that latches the input bit string are additionally provided to the bit string detecting circuit of the first embodiment, so that the bit pattern is detected by inputting signals selected by the switches to the multi-input AND gate.

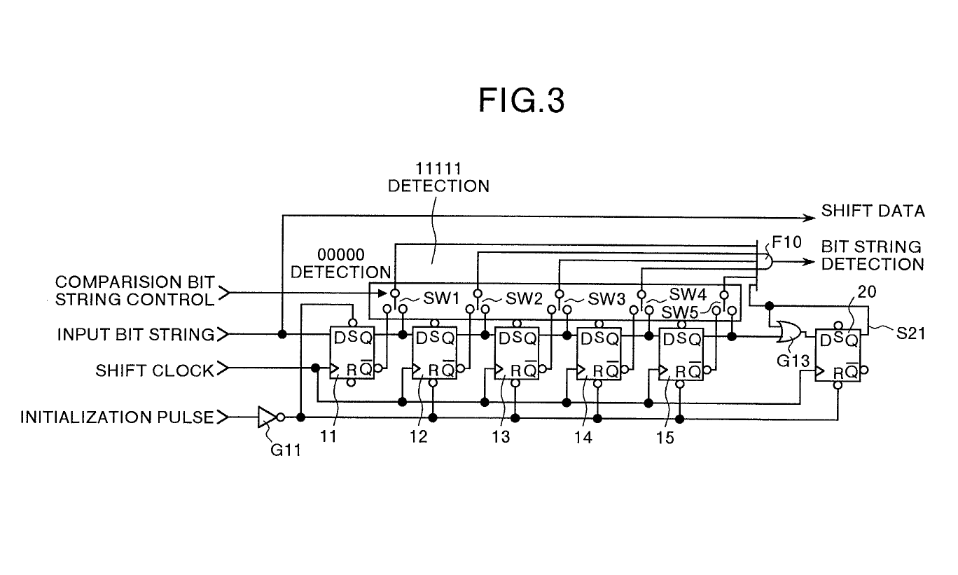

FIG. 3 is a circuit diagram of the bit string detecting circuit of the second embodiment. This figure specifically shows a circuit which detects the bit pattern “11111” or “00000”. In FIG. 3, like components with respect to FIG. 1 are labeled with like legends, and the explanation of these components is not repeated. This bit string detecting circuit comprises, in addition to the D latches 11 to 15, inverter G11, D latch 20, OR gate G13, and multi-input AND gate F10, switches SW1 to SW5 for selecting either the phase data output signal or anti-phase data output signal from each of the D latches 11 to 15, and inputting the selected signals to the multi-input AND gate F10.

The switches SW1 to SW5 are switched collectively by a comparison bit string control signal to select whether the signals inputted into the multi-input AND gate F10 are the signals held in the D latches 11 to 15 or the inversed signals. This means that the bit pattern as an object for comparison can be selected from “11111” and “00000”.

Thus, if the switches SW1 to SW5 are switched so as to make the bit pattern “11111” as the object for comparison, the bit string detecting circuit of the second embodiment has the arrangement equivalent to that explained in the first embodiment, and operates in the same manner. If the switches SW1 to SW5 are switched so as to make the bit pattern “00000” as the object for comparison, the latching operations of the D latches 11 to 15 are the same as those of the detection enabling circuit explained in the first embodiment.

In other words, with the bit string detecting circuit of the second embodiment, the operation explained in the first embodiment is carried out commonly for the different bit patterns, that is, of all the D latches 11 to 15 that sequentially latch the input bit string, the D latch 11 in the first stage alone is set to “1” at initialization, and until that “1” held in the D latch 11 is released from the D latch 15 and latched by the D latch 20, detection of the bit pattern is disabled.

As has been discussed, according to the bit string detecting circuit of the second embodiment, by merely providing the circuit arrangement of the first embodiment with the switches SW1 to SW5 for selectively inputting either the phase data output signal or anti-phase data output signal to the multi-input AND gate F10, the comparing subject can be switched between the bit patterns “11111” and “00000”.

Further, the object for comparison can be made of any desired bit pattern by controlling the switching directions of the switches SW1 to SW5 for their respective D latches separately instead of controlling the switching directions of all the switches SW1 to SW5 collectively to select either the phase data output signal or anti-phase data output signal from each D latch.

In addition, as is with the first embodiment, by changing the stage number of the serially connected D latches and the number of inputs of the multi-input AND gate F10, a bit pattern other than 5-bit long can be detected.

Next, a bit string detecting circuit according to a third embodiment will be explained. The bit string detecting circuit of the third embodiment is characterized in that a multi-input AND gate for receiving an inverted data output from each of the D latches that latch the input bit string and a data output from the D latch that constitutes the detection enabling circuit is additionally provided to the bit string detecting circuit of the first embodiment, so that the bit patterns “11111” and “00000” can be detected.

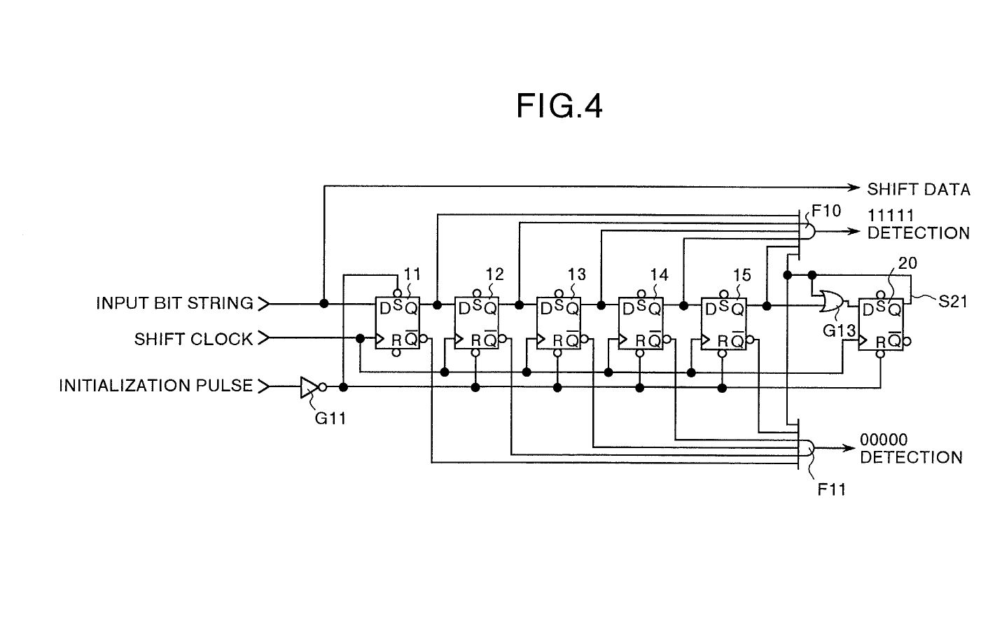

FIG. 4 is a circuit diagram of the bit string detecting circuit of the third embodiment. This figure specifically shows a circuit which detects the bit patterns “11111” and “00000”. In FIG. 4, like components with respect to FIG. 1 are labeled with like legends, and the explanation of these components is not repeated. This bit string detecting circuit comprises, in addition to the D latches 11 to 15, inverter G11, D latch 20, OR gate G13, and multi-input AND gate F10, a multi-input AND gate F11 for receiving an anti-phase data output signal from each of the D latches 11 to 15 and a phase data output signal from the D latch 20.

Consequently, the arrangement same as that explained in the first embodiment functions in detecting the bit pattern “11111”, and the operation is also the same. On the other hand, in detecting the bit pattern “00000”, because the multi-input AND gate F11 receives the signal S21 outputted from the D latch 20, the detection disabled state is maintained and the detection signal of the bit pattern “00000” is not outputted from the multi-input AND gate F11 until the bit string is inputted into all the D latches 11 to 15.

In other words, in the bit string detecting circuit of the third embodiment, the operation explained in the first embodiment is carried out commonly in detecting the different bit patterns “11111” and “00000”, that is, of all the D latches 11 to 15 that sequentially latch the input bit string, the D latch 11 in the first stage alone is set to “1” during the initial stage, and until that “1” held in the D latch 11 is released from the D latch 15 and latched by the D latch 20, detection of the bit pattern is disabled.

As has been discussed, according to the bit string detecting circuit of the third embodiment, by merely providing the circuit arrangement of the first embodiment with the multi-input AND gate F11 for receiving the anti-phase data output signal from each of the D latches 11 to 15 and the phase data output signal from the D latch 20, the bit patterns “11111” and “00000” can be detected.

Also, as is with the first embodiment, by changing the stage number of the serially connected D latches and the number of inputs of the multi-input AND gate F10 or F11, a bit pattern other than 5-bit long can be detected.

Next, a bit string detecting circuit according to a fourth embodiment will be explained. The bit string detecting circuit of the fourth embodiment is characterized in that a magnitude comparator and a register which stores a bit string pattern for comparison are additionally provided to the bit string detecting circuit of the first embodiment. Accordingly, a bit pattern which coincides with the desired bit string pattern in the register can be detected.

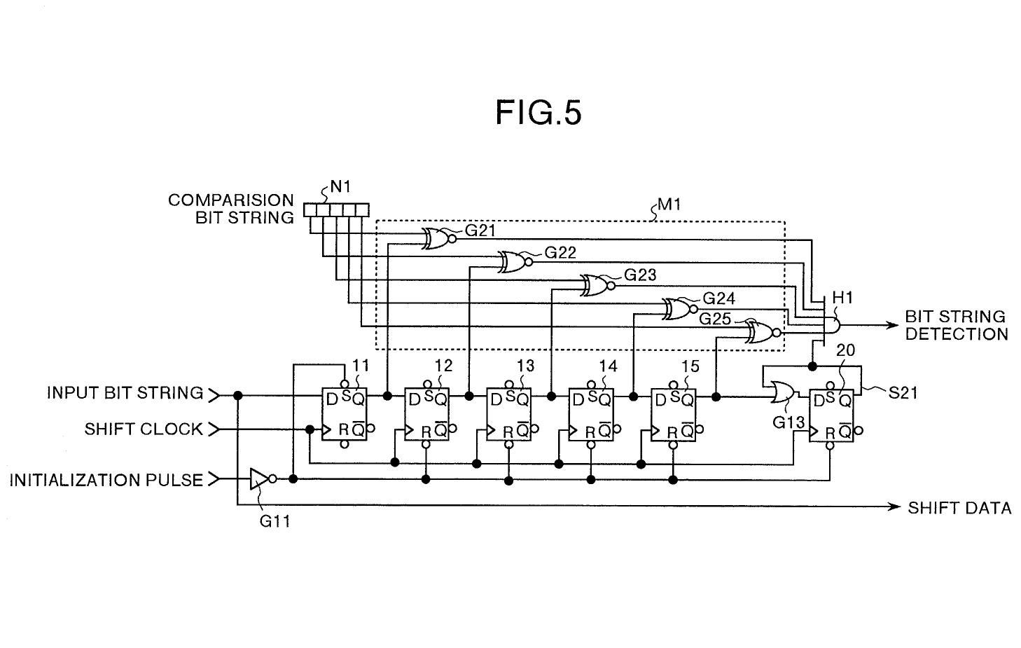

FIG. 5 is a circuit diagram of the bit string detecting circuit of the fourth embodiment. This figure specifically shows a circuit which detects any desired 5-bit bit pattern. In FIG. 5, like components with respect to FIG. 1 are labeled with like legends, and the explanation of these components is not repeated. This bit string detecting circuit comprises, in addition to the D latches 11 to 15, inverter G11, D latch 20, and OR gate G13, EXNOR gates G21 to G25 for receiving phase data output signals from the D latches 11 to 15 at one input terminal and 1-bit data in the comparison bit string stored in a register N1 at the other input terminal.

Also, the bit string detecting circuit of the fourth embodiment includes, instead of the multi-input AND gate F10 shown in FIG. 1, an AND gate H1 for receiving output signals from the EXNOR gates G21 to G25 and the phase data output signal from the D latch 20 to generate a bit string detection signal.

More specifically, the EXNOR gates G21 to G25 constitute a so-called magnitude comparator M1, and assume that the bits forming the comparison bit string are referred to as the first bit, second bit, third bit, fourth bit, and fifth bit from LSB to MSB, then the fifth bit is inputted into one input terminal of the EXNOR gate G21, the fourth bit is inputted into one input terminal of the EXNOR gate G22, the third bit is inputted into one input terminal of the EXNOR gate G23, the second bit is inputted into one input terminal of the EXNOR gate G24, and the first bit is inputted into one input terminal of the EXNOR gate G25.

Thus, for example, if the comparison bit string stored in the register N1 is “10111”, then all the EXNOR gates G21 to G25 output signals having the logical level “1” only when the bit string held in the D latches 11 to 15 is “10111” that coincides with the comparison bit string stored in the register N1. Consequently, when the signal S21 has the logical level “1”, that is, in the detection enabled state, a signal having the logical level “1” is outputted as the bit string detection signal.

The bit string detecting circuit of the fourth embodiment switches from the detection disabled state to the detection enabled state in the same manner as explained in the first embodiment, and the description of which is not repeated. However, the difference with respect to the first embodiment is that, in the detection enabled state, the magnitude comparator M1 compares the bit string latched in the D latches 11 to 15 with the bit string stored in the comparison bit string, and switches the logical levels of the signals from their respective D latches 11 to 15 to “1” and inputs the same to the multi-input AND gate H1.

As has been discussed, according to the bit string detecting circuit of the fourth embodiment, by merely providing the circuit arrangement of the first embodiment with the magnitude comparator and register having stored the comparison bit string pattern, a desired comparison bit string stored in the register can be detected from the signals outputted from the D latches that latch the input bit string.

The fourth embodiment explained a case where a 5-bit bit pattern is detected. However, a bit pattern other than 5-bit long can be detected by changing the stage number of the serially connected D latches, the number of inputs of the multi-input AND gate H1, and the number of the EXNOR gates constituting the magnitude comparator M1.

Next, a bit string detecting circuit according to a fifth embodiment will be explained. The bit string detecting circuit of the fifth embodiment is characterized in that a plurality of magnitude comparators and a plurality of registers for storing comparison bit string patterns are additionally provided to the bit string detecting circuit of the fourth embodiment, so that bit patterns identical with a plurality of different comparison bit strings can be detected simultaneously.

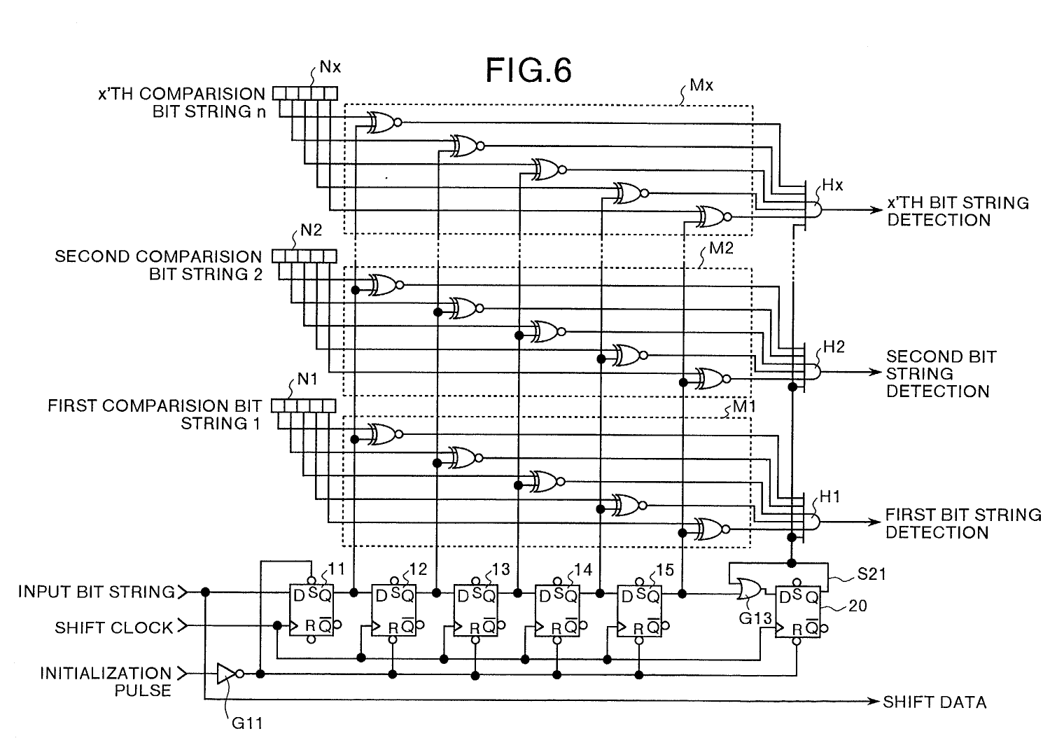

FIG. 6 is a circuit diagram of the bit string detecting circuit of the fifth embodiment. This figure specifically shows a circuit for detecting a plurality of 5-bit different bit patterns. In FIG. 6, like components with respect to FIG. 5 are labeled with like legends, and the explanation of these components is not repeated. This bit string detecting circuit comprises, in addition to the D latches 11 to 15, inverter G11, D latch 20, OR gate G13, register N1 for storing a first comparison bit string, magnitude comparator M1, and multi-input AND gate H1 for detecting the first comparison bit string, registers N2 to Nx for storing the second to x'th comparison bit strings, magnitude comparators M2 to Mx, multi-input AND gates H2 to Hx for detecting the second to x'th comparison bit strings, and a register Nx for storing the x'th comparison bit string.

Like the magnitude comparator M1, each of the magnitude comparators M2 to Mx is composed of five EXNOR gates for receiving phase data output signals from the D latches 11 to 15 at one input terminal. It should be noted, however, that, as shown in FIG. 6 for example, each of the EXNOR gates constituting the magnitude comparators M2 to Mx receives 1-bit data in bit strings forming their respective second to x'th bit strings at the other input terminal.

Also, the multi-input AND gates H2 to Hx receive output signals from the EXNOR gates constituting the magnitude comparators M2 to Mx and a signal outputted from the data output terminal Q of the latch 20, and generates a detection signal as the detection result for each of the second to x'th bit strings.

Consequently, for example, assume that the comparison bit strings are “10111”, “11111”, and “00000”, and when the logical level of the signal S21 is switched to “1”, that is, in the detection enabled state, if the bit string held in the D latches 11 to 15 coincides with the comparing bit “10111”, the multi-input AND gate H1 outputs a signal having the logical level “1” as a detection signal of the first bit string. If the bit string held in the D latches 11 to 15 coincides with the comparing bit “11111”, then the multi-input AND gate H2 outputs a signal having the logical level “1” as a detection signal of the second bit string, and if the bit string held in the D latches 11 to 15 coincides with the comparing bit “00000”, the multi-input AND gate Hx outputs a signal having the logical level “1” as a detection signal of the third bit string.

The bit string detecting circuit of the fifth embodiment switches from the detection disabled state to the detection enabled state in the same manner as explained in the fourth embodiment, and the description of which is not repeated. However, the difference with respect to the fourth embodiment is that, in the detection enabled state, the magnitude comparators M1 to Mx compare the bit string latched in the D latches 11 to 15 with the bit strings stored in the first to x'th registers, and only when the former and latter coincide with each other, a signal having the logical level “1” is outputted from the multi-input AND gate corresponding to the coinciding bit string.

As has been discussed, according to the bit string detecting circuit of the fifth embodiment, by merely providing the circuit arrangement of the fourth embodiment with a plurality of magnitude comparators and registers having stored the comparison bit string patterns, desired comparison bit strings stored in the plurality of registers can be detected simultaneously from the signals outputted from the D latches that latch the input bit string.

As is with the fourth embodiment, a bit pattern other than 5-bit long can be also detected in the fifth embodiment by changing the stage number of the serially connected D latches, the number of inputs of the multi-input AND gates, and the number of the EXNOR gates constituting each magnitude comparator.

Next, a bit string detecting circuit according to a sixth embodiment will now be explained. The bit string detecting circuit of the sixth embodiment is characterized in that OR gates in the matching number with D latches that latch the input bit string are provided at the preceding stage of the multi-input AND gate for generating a bit string detection signal in the bit string detecting circuit of the first embodiment in such a manner that the OR gates receive phase data output signals from the corresponding D latches at one input terminal and bit length control signals at the other input terminal, so that a part of the bit string latched by the D latches is validated as a detection subject.

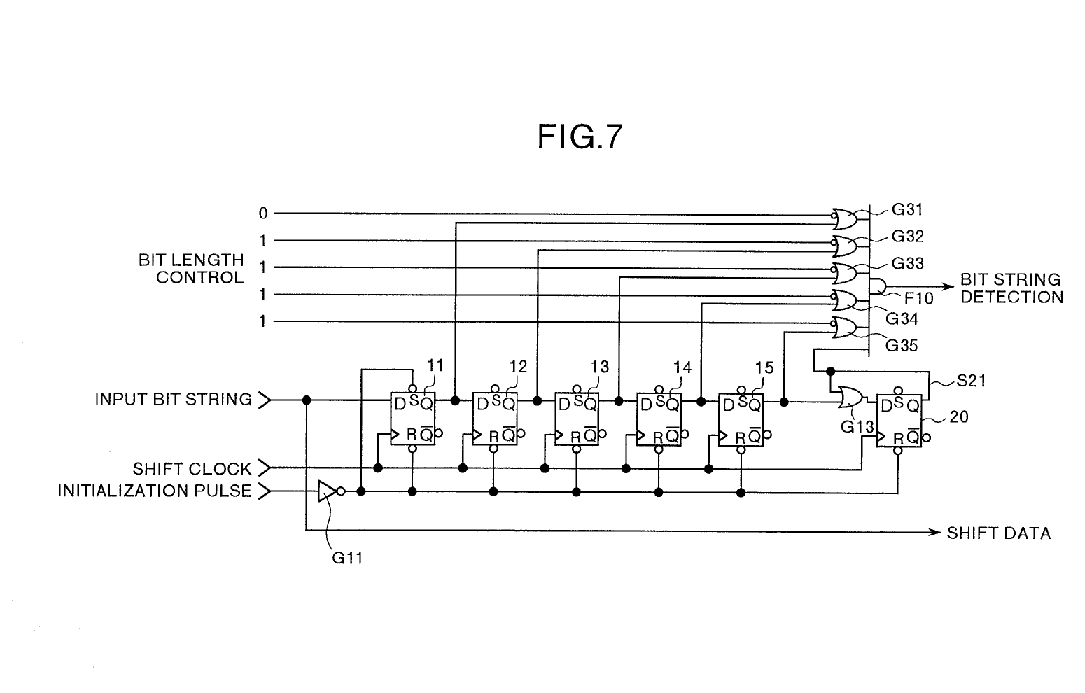

FIG. 7 is a circuit diagram of a bit string detecting circuit of the sixth embodiment. This figure specifically shows a case where a desired 5-bit bit string is latched, and whether the bit pattern latched in the D latches 12 to 15 of the latched bit string coincides with “1111” or not is judged. In FIG. 7, like components with respect to FIG. 1 are labeled with like legends, and the explanation of these components is not repeated.

This bit string detecting circuit comprises, in addition to the D latches 11 to 15, inverter G11, D latch 20, OR gate G13, and multi-input AND gate F10, 1-inverting input OR gates G31 to G35 for receiving phase data output signals from D latches 11 to 15 at one input terminal and bit control signals, which are inputted from the external and inverted, at the other input terminal. The multi-input AND gate F10 receives output signals from the 1-inverting input OR gates G31 to G35 and a phase data output signal from the D latch 20.

Thus, each of the 1-inverting input OR gates G31 to G35 outputs the logical level “1” irrespective of the logical state of the signal inputted into one input terminal when the bit-length control signal inputted into the other input terminal has the logical level “0”. This means that the D latch that inputs a signal to the OR gate that receives the bit length control signal having the logical level “0” is set aside from the bit pattern of the detection subject.

For example, as shown in FIG. 7, assume that the bit length control signals “0”, “1”, “1”, “1”, and “1” are inputted into the 1-inverting input OR gates G31, G32, G33, G34, and G35, respectively, then the 1-inverting input OR gate G31 inputs a signal having the logical level “1” to the multi-input AND gate F10 regardless of the state of data held in the D latch 11. On the other hand, the 1-inverting input OR gates G32 to G35 input signals having the logical level same as that of the data held in the corresponding D latches 12 to 15 to the multi-input AND gate F10. In other words, in the detection enabled state, the multi-input AND gate F10 outputs a signal having the logical level “1” as the bit string detection signal only when the bit pattern held in the D latches 12 to 15 is “1111”.

The bit string detecting circuit of the sixth embodiment switches from the detection disabled state to the detection enabled state in the same manner as explained in the first embodiment, and the description of which is not repeated. However, the difference with respect to the first embodiment is that, as has been discussed, the bits of the detection subject in the bit string held in the D latches 11 to 15 are limited in accordance with the bit length control signals in the detection enabled state.

As has been discussed, according to the bit string detecting circuit of the sixth embodiment, the circuit arrangement of the first embodiment is further arranged in such a manner that five 1-inverting input OR gates G31 to G35 are provided in the matching number with the D latches 11 to 15 that latch the input bit string in the preceding stage of the multi-input AND gate F10 for generating the bit string detection signal, and the phase data output signals from the corresponding D latches are inputted into one input terminals of the 1-inverting input OR gates G31 to G35 and the bit length control signals to the other input terminal, while the output signals from the 1-inverting input OR gates G31 to G35 are inputted into the multi-input AND gate F10. Consequently, a part of the bit string latched by the D latches 11 to 15 can be validated in response to the bit length control signals, in other words, a bit length of the bit pattern of the detection subject can be selected as desired.

The sixth embodiment explained a case where a bit pattern “11111” up to 5-bit long can be detected. However, a bit pattern “00000” up to 5-bit long can be detected as well by connecting input terminals of the 1-inverting input OR gates G31 to G35 not to the data output terminals Q, but to the inverting data output terminals /Q of the corresponding D latches. In addition, any desired bit pattern can be detected by selecting either the phase data output signal or anti-phase data output signal from each D latch separately, and inputting the same to their respective 1-inverting input OR gates G31 to G35. Further, by changing the stage number of the serially connected D latches, the number of inputs of the multi-input AND gate F10, the number of the 1-inverting input OR gates, and the number of the bit length control signals, the variable longest bit length can be greater than five.

Next, a bit string detecting circuit according to a seventh embodiment will now be explained. The bit string detecting circuit of the seventh embodiment is characterized in that the arrangement of magnitude comparator and register explained in the fourth embodiment is added to the bit string detecting circuit of the sixth embodiment, so that not only can a part of the bit string latched in the D latches that latch the input bit string be validated as the detection subject, but also a bit pattern that coincides with a desired comparison bit string stored in the register can be detected.

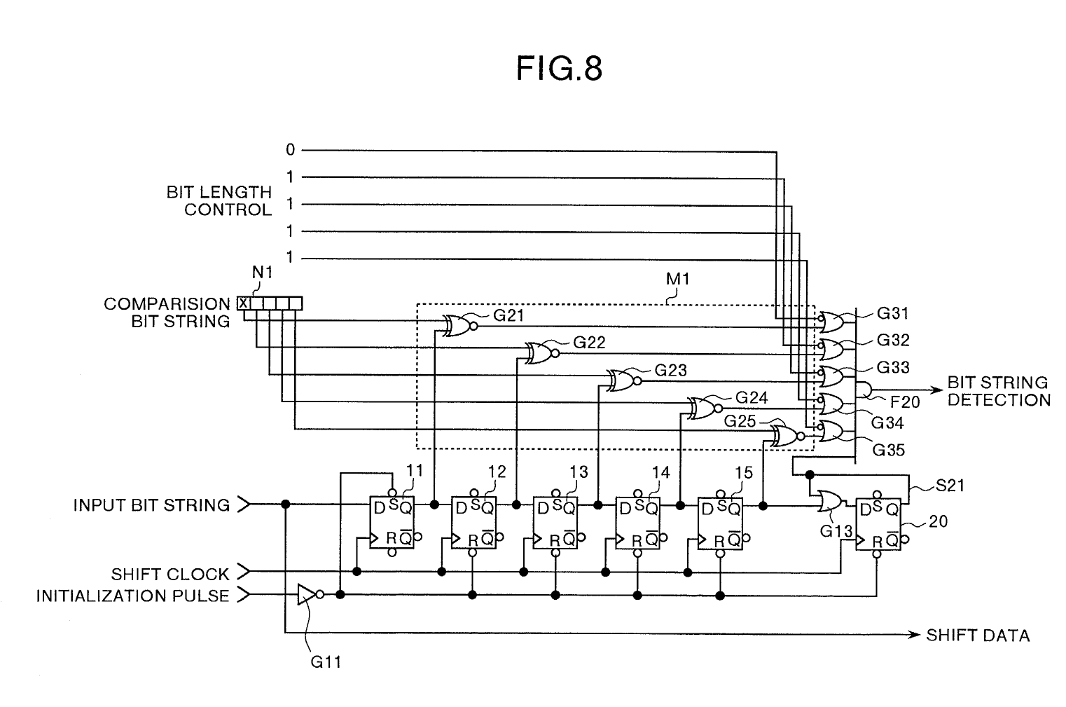

FIG. 8 is a circuit diagram of the bit string detecting circuit of the seventh embodiment. This figure specifically shows a case where a desired 5-bit string is latched, and it is judged whether the bit pattern held in the D latches 12 to 15 in the latched bit string coincides with the lower four bits of the comparison bit string stored in the register N1. In FIG. 8, like components with respect to FIG. 5 and FIG. 7 are labeled with like legends, and the explanation of these components is not repeated.

This bit string detecting circuit comprises in addition to the D latches 11 to 15, inverter G11, D latch 20, OR gate G13, and 1-inverting input OR gates G31 to G35, EXNOR gates G21 to G25 for receiving signals outputted from the data output terminals Q of the corresponding D latches 11 to 15 at one input terminals and 1-bit data of the comparison bit string stored in the register N1 at the other input terminal.

Also, the bit string detecting circuit of the seventh embodiment includes, instead of the multi-input AND gate F10 shown in FIG. 7, an AND gate F20 for receiving output signals from the 1-inverting input OR gates G31 to G35 and a phase data output signal from the D latch 20 to generate a bit string detection signal.

More specifically, the EXNOR gates G21 to G25 constitute a so-called magnitude comparator M1, and assume that the bits forming the comparison bit string are referred to as the first bit, second bit, third bit, fourth bit, and fifth bit from LSB to MSB, then the fifth bit is inputted into one input terminal of the EXNOR gate G21, the fourth bit is inputted into one input terminal of the EXNOR gate G22, the third bit is inputted into one input terminal of the EXNOR gate G23, the second bit is inputted into one input terminal of the EXNOR gate G24, and the first bit is inputted into one input terminal of the EXNOR gate G25.

Thus, for example, if the comparison bit string stored in the register N1 is “10111”, all the EXNOR gates G21 to G25 output signals having the logical level “1” only when the bit string held in the D latches 11 to 15 is “10111” that coincides with the comparison bit string. However, as shown in FIG. 8, in case that bit length control signals “0”, “1”, “1”, “1”, and “1” are inputted into the OR gates G31, G32, G33, G34, and G35, respectively, the OR gate G31 inputs a signal having the logical level “1” to the multi-input AND gate F20 irrespective of the state of data held in the D latch 11.

In other words, in the detection enabled state, if the bit pattern held in the D latches 12 to 15 coincides with the lower four bits of the comparison bit string “0111”, the multi-input AND gate F20 outputs a signal having the logical level “1” as the bit string detection signal. Thus, in this case, the MSB of the comparison bit string, which is not the detection subject, can be in any state.

The bit string detecting circuit of the seventh embodiment switches from the detection disabled state to the detection enabled state in the same manner as explained in the first embodiment, and the description of which is not repeated. However, the difference with respect to the first embodiment is that, in the detection enabled state, the magnitude comparator M1 compares the bit string latched by the D latch 11 to 15 with the bit string stored in the comparison bit string, and when the former and latter coincide with each other, it shifts the logical level of the signals from the D latches 11 to 15 to “1” and inputs the same to the multi-input AND gate H1, and that the bits of the detection subject in the bit string held in the D latches 11 to 15 are limited in accordance with the bit length control signals.

As has been discussed, according to the bit string detecting circuit of the seventh embodiment, by merely providing the circuit arrangement of the sixth embodiment with the magnitude comparator and register having stored the comparison bit string pattern, not only can the bit length of the bit pattern of the detection subject be selected as desired, but also a desired comparison bit string stored in the register can be detected from the signals outputted from the D latches that latch the input bit string.

The seventh embodiment explained a case where a bit pattern up to 5-bit long can be detected. However, a variable longest bit length can be greater than five by changing the stage number of the serially connected D latches, the number of inputs of the multi-input AND gate F20, the number of 1-inverting input OR gates, the number of the bit length control signals, and the number of the EXNOR gates constituting the magnitude comparator M1.

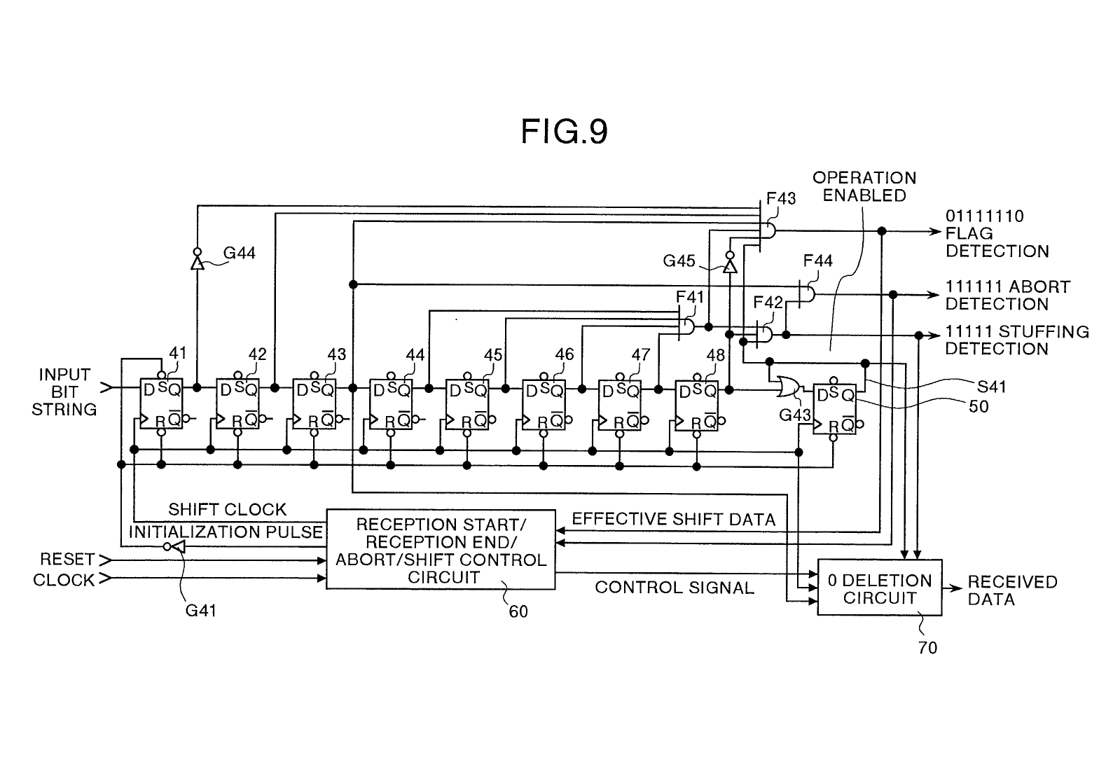

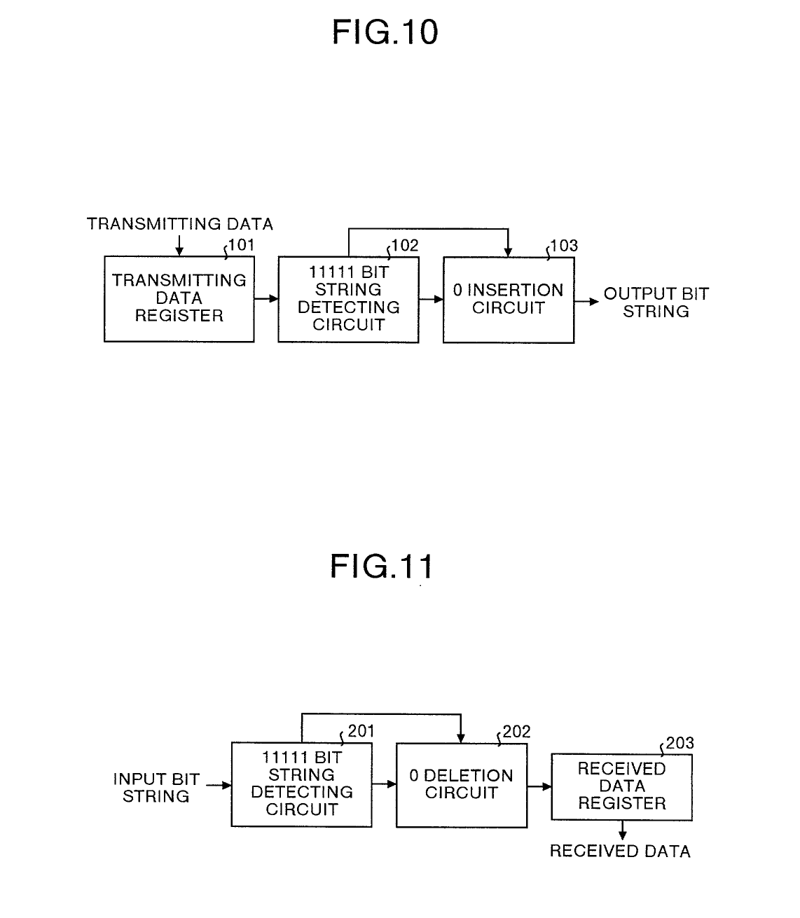

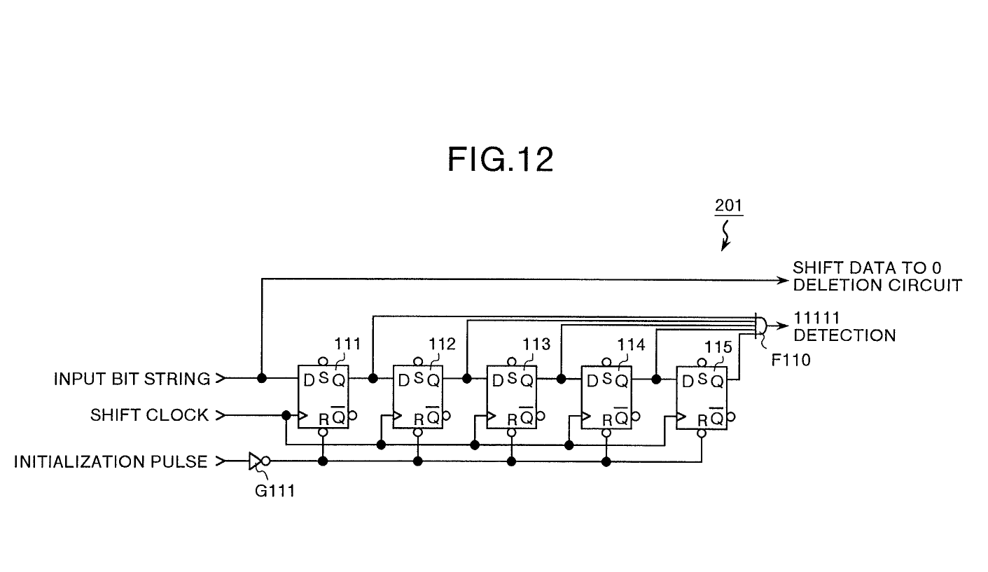

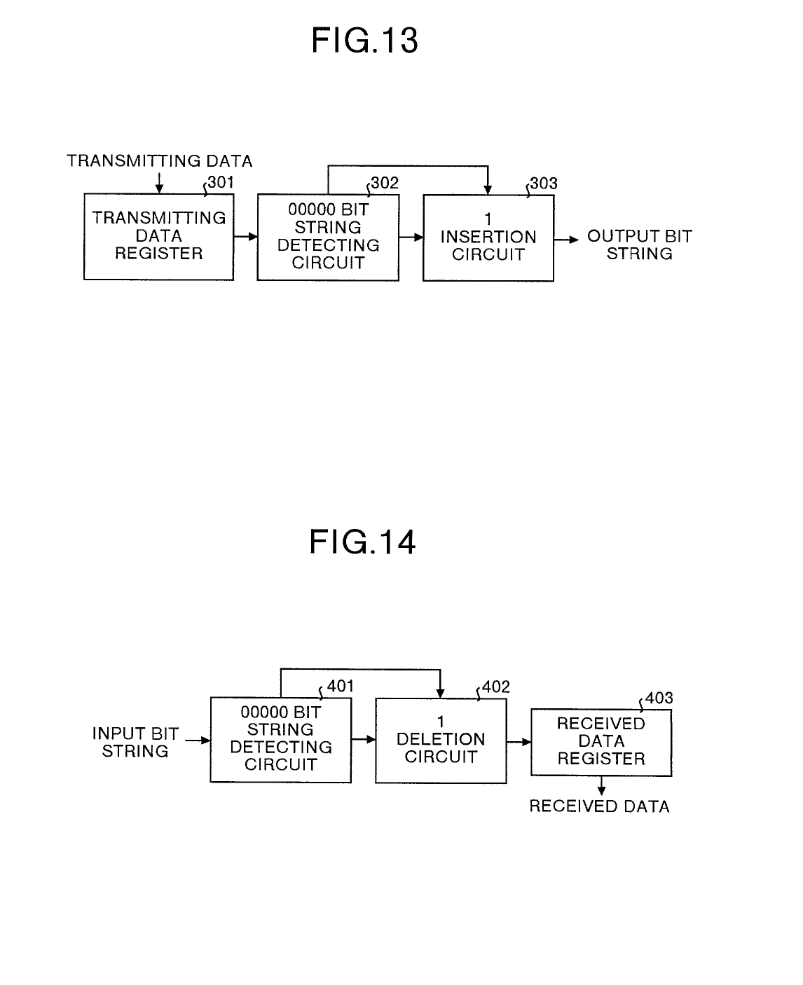

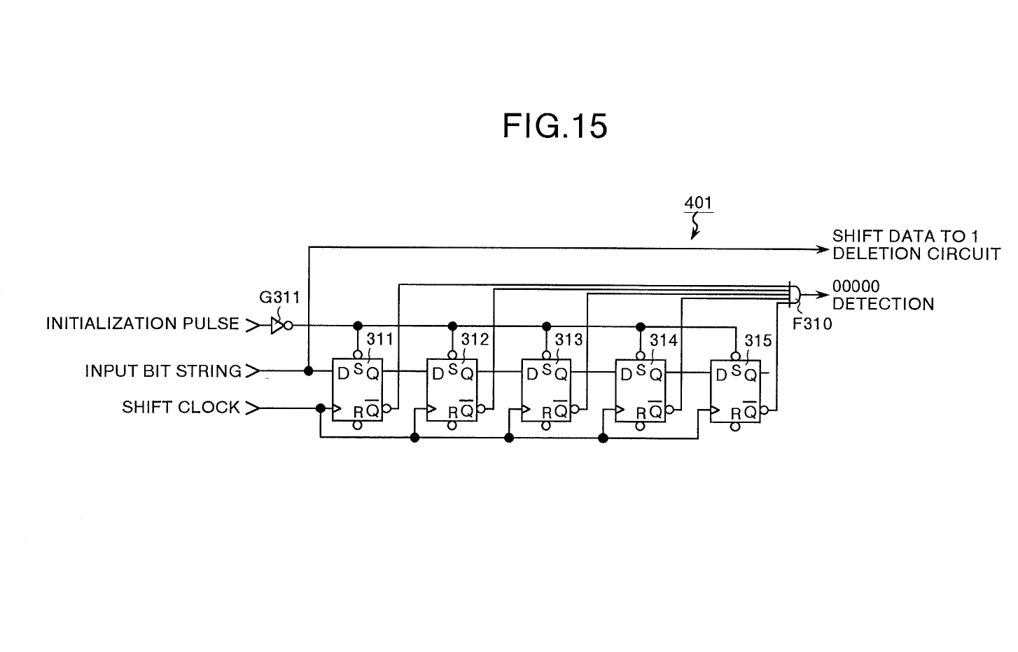

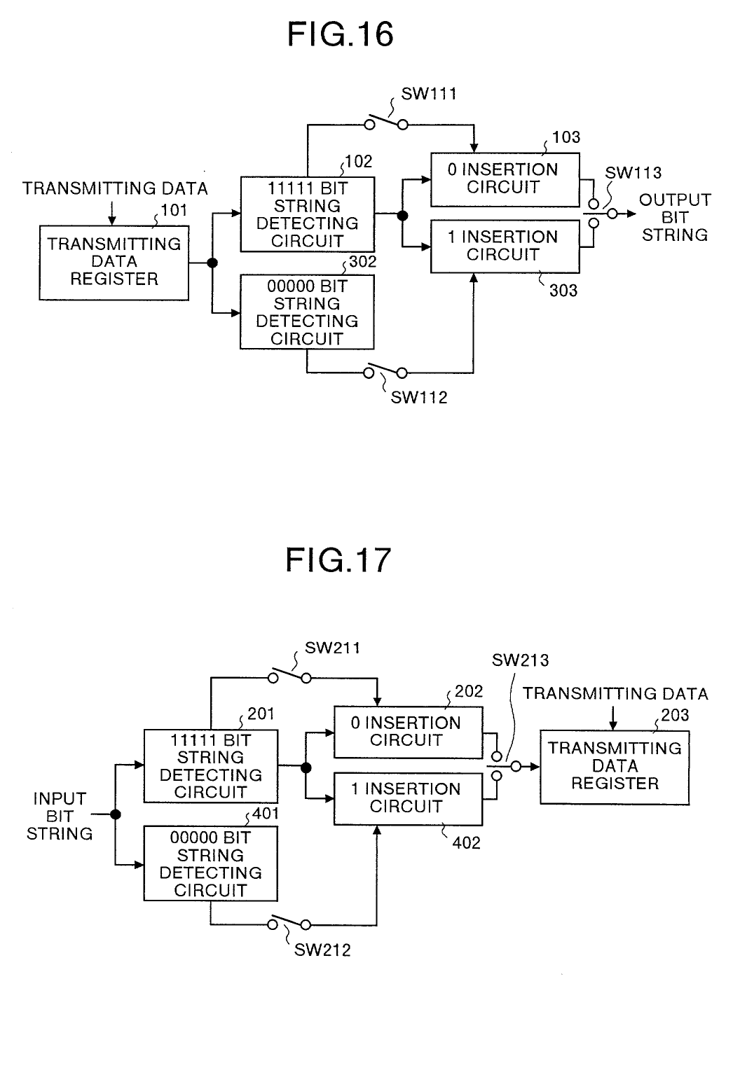

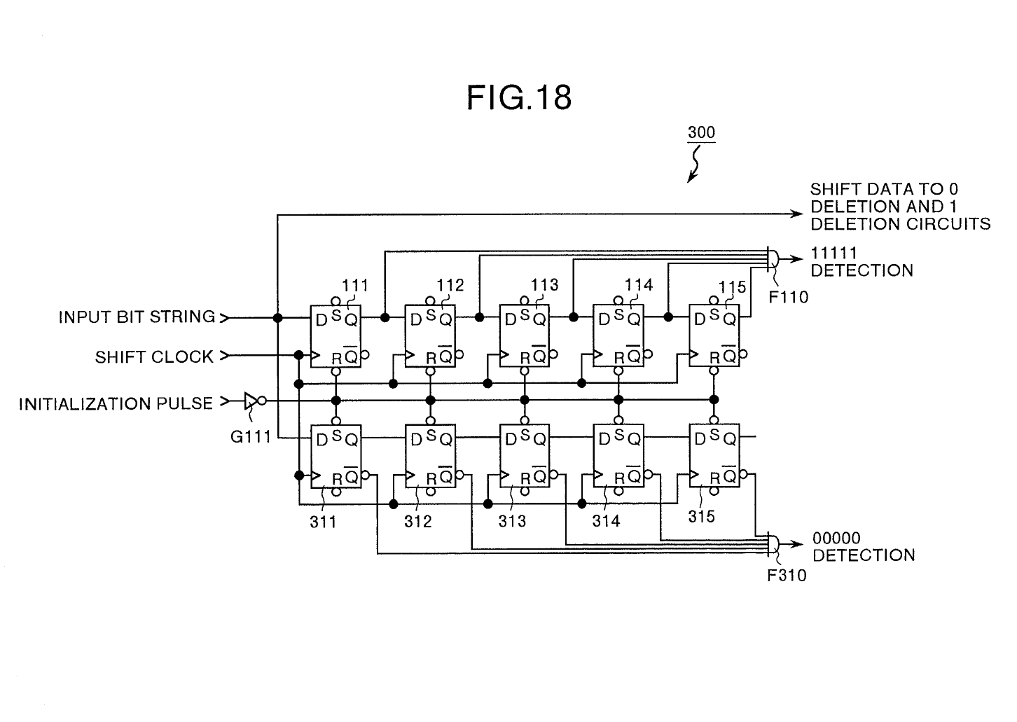

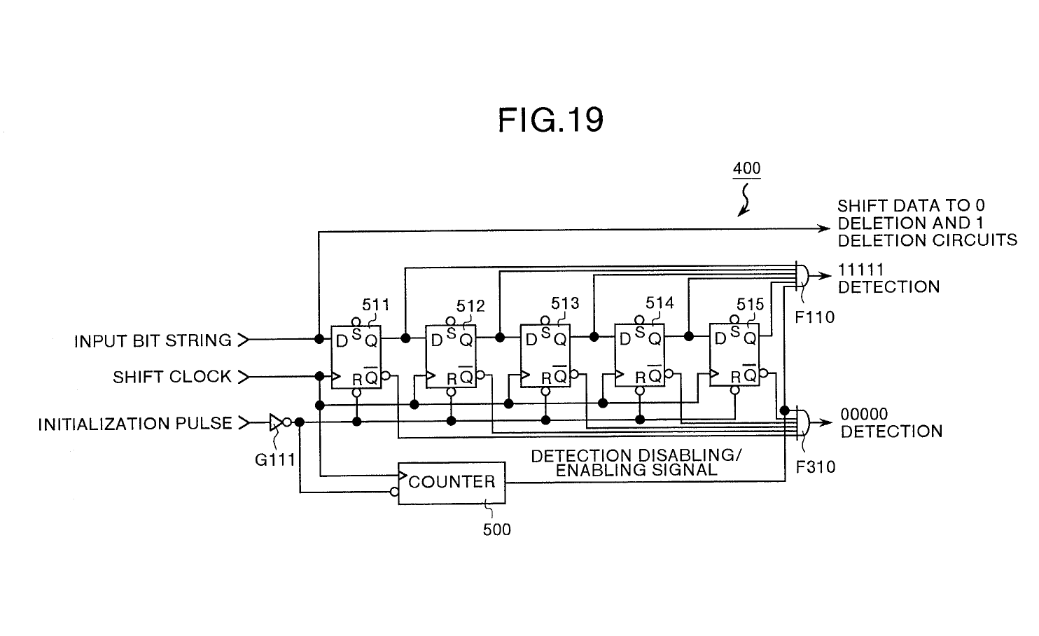

Next, a bit string detecting circuit according to an eighth embodiment will now be explained. The bit string detecting circuit of the eighth embodiment is an example case where the bit string detecting circuit of the first embodiment is applied to an HDLC receiving circuit. FIG. 9 is a circuit diagram of an HDLC receiving circuit adapting the bit string detecting circuit of the eighth embodiment.

This HDLC receiving circuit comprises a bit string detecting circuit, a reception start/reception end/abort/shift control circuit 60, and a 0 deletion circuit 70. The bit string detecting circuit includes an OR gate G43 which plays the same role as the OR gate G13 shown in FIG. 1, a D latch 50 which plays the same role as the D latch 20 shown in FIG. 1, D latches 41 to 48 for latching an input bit string, an inverter G44 for inverting a signal outputted from the data output terminal Q of the D latch 41, an inverter G45 for inverting a signal outputted from the data output terminal Q of the D latch 48, and multi-input AND gates F41, F42, F43, and F44.

The multi-input AND gate F41 receives phase data output signals from the D latches 44 to 47 and the multi-input AND gate F42 receives an output signal from the multi-input AND gate F41, a phase data output signal form the D latch 48, and a phase data output signal S41 from the D latch 50. The multi-input AND gate F42 receives an output signal from the inverter G44 and phase data output signals from the D latches 42 and 43, and the multi-input AND gate F43 receives an output signal from the multi-input AND gate F41, an output signal from the inverter G45, and the phase data output signal S41 from the D latch 50. Also, the multi-input AND gate F44 receives a phase data output signal from the D latch 43 and an output signal from the multi-input AND gate F42.

Hence, the multi-input AND gate F43 outputs a 01111110 flag detection signal having the logical level “1” when the bit string latched by the D latches 41 to 48 coincides with a bit pattern “01111110”. Also, in the detection enabled state, the multi-input AND gate F42 outputs a 11111 stuffing detection signal having the logical level “1” when the bit string latched by the D latches 44 to 48 coincides with a bit pattern “11111”. In addition, in the detection enabled state, the multi-input AND gate F44 outputs a 111111 abort detection signal having the logical level “1” when the bit string latched by the D latches 43 to 48 coincides with a bit pattern “111111”.

On the other hand, the reception start/reception end/abort/shift control circuit 60 initializes the self (the reception start/reception end/abort/shift control circuit 60) and generates an initialization pulse in response to a reset signal inputted from the external, and transfers a clock signal inputted from the external to the D latches 41 to 48 and 50 and the 0 deletion circuit 70. The reception start/reception end/abort/shift control circuit 60 generates the initialization pulse even when it receives the 01111110 flag detection signal and 111111 abort detection signal. Also, the reception start/reception end/abort/shift control circuit 60 generates a control signal for controlling, for example, suspension of the deletion operation of the 0 deletion circuit 70.

Also, the 0 deletion circuit 70 receives the signal S41 and 11111 stuffing detection signal, and in the detection enabled state, that is, in the state where the signal S41 having the logical level “1” is inputted, it effects the 0 deletion on signals sequentially outputted from the data output terminal Q of the D latch 43.

Next, operation of the HDLC receiving circuit will be explained. In order to activate the HDLC receiving circuit, a reset signal is inputted into the reception start/reception end/abort/shift control circuit 60 from the external, whereupon the initialization pulse is generated. The generated pulse sets the D latch 41 to “1” and resets the D latches 42 to 48 and 50 to “0”.

Subsequently, a shift clock is inputted into the D latches 41 to 48 and 50 through the reception start/reception end/abort/shift control circuit 60, and an input bit string is latched sequentially from the D latch 41 in synchronization with the shift clock. The operation of the bit string control circuit is the same as that explained in the first embodiment, and the explanation of which is not repeated.

When the first bit of the input bit string reaches the D latch 50, the detection disabled state is switched to the detection enabled state, and upon input of the signal S41 having the logical level “1”, the multi-AND gates F41, F42, and F44 start to detect three kinds of bit strings as to the 8-bit flag 01111110, 6-bit abort 111111, and 5-bit bit stuffing 11111, respectively.

When the input bit string latched by the D latches 41 to 48 coincides with the bit pattern “01111110”, the multi-input AND gate F43 outputs the 01111110 flag detection signal having the logical level “1”. The 01111110 flag detection signal is inputted into the reception start/reception end/abort/shift control circuit 60, whereupon the initialization pulse is generated again. In short, the foregoing operation immediately after the reset is started again.

After the initialization by the 01111110 flag detection signal, the data shift-inputted into the latches 41 to 48 as the input bit string is transferred from the output of the latch 43 to the 0 deletion circuit 70 in the following stage as an effective shift data string. When the input bit string latched by the D latches 44 to 48 coincides with the bit pattern “11111”, the multi-input AND gate F42 outputs the 11111 stuffing detection signal having the logical level “1”. The 11111 stuffing detection signal is inputted into the 0 deletion circuit 70, and in response to this input, the 0 deletion circuit 70 deletes the bit 0 immediately after the input bit string “11111”.

In addition, when the input bit string latched by the D latches 43 to 48 coincides with the bit pattern “111111”, the multi-input AND gate F44 outputs the 111111 abort detection signal having the logical level “1”. The 111111 abort detection signal is inputted into the reception start/reception end/abort/shift control circuit 60, whereupon the initialization pulse is generated again, and the current job is suspended and the operation immediately after the foregoing reset is started again.

As has been explained, according to the HDLC receiving circuit adapting the bit string detecting circuit of the eighth embodiment, three kinds of bit strings including the 8-bit flag 01111110, 6-bit abort 111111, and 5-bit bit stuffing 11111 can be detected simultaneously. Consequently, not only can the number of components of the circuit be reduced, but also the costs can be saved.

As has been discussed, according to the present invention, the first latch unit in the first stage of the bit string detecting circuit is set with a data bit having the first logical state at the initialization, and the detection enabling signal is continuously inputted into the bit string detecting unit when and after the above bit data reaches the detection enabling unit through the second latch unit in synchronization with the clock. Thus, there is obtained an effect that the bit string detecting function is maintained in the disabled state until the detection subject data is inputted into the first latch unit and the second latch unit to their full. Also, there can be offered another effect that, because a detectable bit pattern is not limited, for example, the same bit string detecting circuit can be used in detecting different bit strings, such as a bit string 11111 and a bit string 00000.

Further, the detection enabling unit is realized by a relatively simple circuit arrangement composed of the third latch unit and the combinational circuit for outputting a detection enabling signal by outputting the data bit inputted from the second latch unit to the third latch unit when a data bit held in the third latch unit has the second logical state, and when the data bit held in the third latch unit has the first logical state, inputting the data bit having the first logical state to the third latch unit.

Further, the detection of the bit string can be realized by the logical operation of the output signals from the first latch unit and the second latch unit and the detection enabling signal. Thus there can be offered an effect that the bit string detecting unit can be realized readily by a logical circuit, such as an AND gate. Further, a signal inputted into the bit string detecting unit can be switched between the phase data output signals and anti-phase data output signals from the first latch unit and the second latch unit by the switching unit. Thus, for example, a bit string 11111 and a bit string 00000 can be detected by a single bit string detecting circuit, and there can be offered an effect that a plurality of bit patterns can be detected by a common circuit arrangement.

Further, the first logic circuit conducts the logical operation of the phase data output signals from the first latch unit and the second latch unit to generate the first bit string detection signal, and the second logic circuit conducts the logical operation of the anti-phase data output signals from the first latch unit and the second latch unit to generate the second bit string detection signal. Thus, for example, a bit string 11111 and a bit string 00000 can be detected simultaneously by a single bit string detecting circuit, and there can be offered an effect that a plurality of bit patterns can be detected simultaneously by a common circuit arrangement.

Further, the bit string detection signal is outputted when the bit string held in the first latch unit and the second latch unit coincides with the bit string stored in the storage unit. Thus, there can be offered an effect that any desired bit pattern can be detected.

Further, the bit string detection signal is outputted when the bit string held in the first latch unit and the second latch unit coincides with any of a plurality of different bit strings stored in the storage unit. Thus, there can be offered an effect that a plurality of desired bit patterns can be detected simultaneously by a common circuit arrangement.

Further, a part of the output signals form the first latch unit and the second latch unit can be validated as the detection subject by the bit length control signal. Thus, there can be offered an effect that a bit length of the bit string of the detection subject can be readily changed.

Further, a part of the output signals from the first latch unit and the second latch unit can be validated as the detection subject by the bit length control signal. While at the same time, the bit string detection signal is outputted when the validated part of the bit string of the output signals coincides with the bit string stored in the storage unit. Consequently, there can be offered an effect that not only can a desired bit string be detected, but also a bit length of the bit string of the detection subject can be readily changed.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A bit string detecting circuit comprising:
a first latch unit which sequentially latches a serial bit string in synchronization with a clock and holds a data bit having a first logical state in an initialized state;
at least one second latch unit connected in series to said first latch unit in the downstream side, wherein said second latch unit sequentially latches the data bit held in said first latch unit in synchronization with the clock and holds a data bit having a second logical state, which is different from the first logical state, in the initialization state;
a detection enabling unit connected in series to said second latch unit in the downstream side, wherein said detection enabling unit holds the data bit having said second logical state in the initialized state and receives the data bit released and inputted from said second latch unit in synchronization with the clock, and continues to output a detection enabling signal when the inputted data bit has the first logical state; and
a bit string detecting unit which outputs a bit string detection signal when a bit pattern formed by the data bits held in said first latch unit and said second latch unit coincides with a predetermined bit pattern in response to the detection enabling signal.

2. The bit string detecting circuit according to claim 1, wherein said detection enabling unit includes,
a third latch unit; and
a combination circuit which outputs the detection enabling signal by receiving the data bit released and inputted from said second latch unit in synchronization with the clock, outputs the inputted data bit to said third latch unit when a data bit held in said third latch unit has the second logical state, and when the data bit held in said third latch unit has the first logical state, and inputs the data bit having the first logical state to said third latch unit.

3. The bit string detecting circuit according to claim 1, wherein said bit string detecting unit conducts a logical operation of an output signal from said first latch unit, an output signal from said second latch unit, and said detection enabling signal, and outputs the bit string detection signal in accordance with a result of the logical operation.

4. The bit string detecting circuit according to claim 1, further comprising:
a switching unit which receives phase data output signals inputted from said first latch unit and said second latch unit and anti-phase data output signals inputted from said first latch unit and said second latch unit, and selectively switches and outputs any one of the phase data output signals and anti-phase data output signals,
wherein said bit string detecting unit conducts a logical operation of a signal outputted from said switching unit and the detection enabling signal and outputs the bit string detection signal in accordance with a result of the logical operation.

5. The bit string detecting circuit according to claim 1, wherein said bit string detecting unit includes,
a first logic circuit which conducts a logical operation of phase data output signals from said first latch unit and said second latch unit and the detection enabling signal, and outputs a first bit string detection signal in accordance with a result of the logical operation; and
a second logic circuit which conducts a logical operation of anti-phase data output signals from said first latch unit and said second latch unit and the detection enabling signal, and outputs a second bit string detection signal in accordance with a result of the logical operation.

6. The bit string detecting circuit according to claim 1, further comprising:
a bit string comparing unit which receives output signals inputted from said first latch unit and said second latch unit, compares a bit string formed by the output signals thus inputted with a bit string stored in a predetermined storage unit, and outputs a comparison signal which indicates the result of comparison,
wherein said bit string detecting unit conducts a logical operation of the detection enabling signal and comparison signal and outputs the bit string detection signal in accordance with a result of the logical operation.

7. The bit string detecting circuit according to claim 1, further comprising:
a plurality of bit comparing unit which compare a bit string formed by the data bits held in said first latch unit and said second latch unit with a plurality of different bit strings stored in a predetermined storage unit,
wherein said bit string detecting unit conducts a logical operation of the detection enabling signal and the result of comparison by each of said bit string comparing unit, and outputs the bit string detection signals each being different from the others depending on the result of comparison.

8. The bit string detecting circuit according to claim 1, further comprising:
a bit length controlling unit which receives output signals inputted from said first latch unit and said second latch unit, and validates a part of the output signals thus inputted in accordance with a bit length control signal inputted from an external to output said part,
wherein said bit string detecting unit conducts a logical operation of the detection enabling signal and said part of the output signals validated by said bit length control unit, and outputs said bit string detection signal in accordance with a result of the logical operation.

9. The bit string detecting circuit according to claim 1, further comprising:
a bit string comparing unit which receives output signals inputted from said first latch unit and said second latch unit, compares a bit string formed by the output signals thus inputted with a bit string stored in a predetermined storage unit, and outputs a comparison signal which indicates the result of comparison along with the output of each of the output signals; and
a bit length control unit which receives the comparison signals and validates a part of the comparing signals in accordance with a bit length control signal inputted from an external to output said part,
wherein said bit string detecting unit conducts a logical operation of the detection enabling signal and the part of the comparing signals validated by said bit length control unit, and outputs said bit string detection signal in accordance with a result of the logical operation.
